(19) United States
(12) Patent Application Publication
(10) Pub. No.: US 2025/0227415 A1
(43) Pub. Date: Jul. 10, 2025

(54) SYSTEMS AND METHODS FOR CONTROLLING AUDIO DEVICES

(71) Applicant: Bose Corporation, Framingham, MA (US)

(72) Inventors: Rasmus Abildgren, Skørping (DK); Casper Stork Bonde, Støvring (DK); Christopher St John, King's Lynn (GB)

(73) Assignee: Bose Corporation, Framingham, MA (US)

(21) Appl. No.: 18/405,463

(22) Filed: Jan. 5, 2024

(51) Int. Cl. H04R 5/04; H04L 65/611

(52) U.S. Cl. CPC H04R 5/04; H04L 65/611; H04R 2420/07

(57) ABSTRACT

A method for controlling one or more audio devices is provided. The method includes transmitting, from a first audio device, a broadcast stream. The method further includes receiving input data from a second audio device. The second audio device is configured to receive the broadcast stream from the first audio device. The input data is related to adjusting playback of the broadcast stream. The method further includes transmitting command data from the first audio device to one or more other audio devices. The command data is based on the input data. The command data is time synchronized with the broadcast stream to prevent overlap with the broadcast stream. A broadcast protocol data unit of the broadcast stream may include audio data and/or the command data.

### FIELD OF THE DISCLOSURE

The present disclosure is generally directed to systems and methods for controlling audio devices, and more particularly, to controlling audio devices via a combination of mesh advertisements and broadcast isochronous streams.

### BACKGROUND

As Bluetooth-enabled wireless speakers become more common, it would be advantageous to enable a user to control a group of several wireless speakers to, for example, change a volume level of all wireless speakers simultaneously.

### SUMMARY

The present disclosure is generally directed to systems and methods for controlling audio devices. In particular, the systems and methods use a combination of mesh advertisements and broadcast audio streams to control the audio devices. Critically, the broadcast audio stream and the transmissions of the mesh advertisements are time synchronized to prevent temporal overlap, thereby enabling all audio devices within range to receive both the broadcast audio stream and the mesh advertisements. The broadcast audio streams are implemented according to the Bluetooth Low Energy (LE) Audio protocol. An example system may include a first audio device, a second audio device, and one or more additional audio devices. Each of these audio devices may be any type of Bluetooth enabled audio device, such as speakers. The first audio device may transmit a broadcast audio stream, such that the audio of the broadcast audio stream is rendered by the second audio device and each of the additional audio devices. Optionally, the first audio device may also render audio of the broadcast stream. The second audio device receives (such as via a user interface) input data corresponding to a playback adjustment of the broadcast audio stream, such as a volume level change. The second audio device then transmits a mesh protocol data unit (PDU) containing data corresponding to the desired playback adjustment. The first audio device receives the mesh PDU and extracts data corresponding to the desired playback adjustment. The first audio device then generates command data based on the desired playback adjustment, and embeds the command data into the broadcast audio stream. In some example, generating the command data may including duplicating, copying, or relaying data received from the second audio device. Accordingly, when the broadcast audio stream is received by the additional audio devices, the additional audio devices also receive the command data to implement the desired playback adjustment, and all of the audio devices in the system may then execute the same playback adjustment.

As demonstrated by the description above, the system enables the playback adjustment corresponding to the input data received by the second audio device to reach the additional audio devices even if the additional audio devices are outside of the transmission range of the second audio device. In some examples, the first device may simply relay the input data from the second audio device as command data. In other examples, the first audio device or the second audio device may process the input data to generate command data appropriate to provide to the other audio devices. The command data may include timing information ensuring that the audio devices implement the playback adjustment in a synchronized manner (such as all audio devices lowering their volume simultaneously). The timing information may be determined relative to the broadcast audio stream. Further, in some examples, an external device (such as a smartphone) connected to the second audio device may provide the input data. Similarly, another external device connected to the first audio device may provide the audio data for the broadcast audio stream.

In some examples, following the execution of the playback adjustment by the additional audio devices, the additional audio devices transmit feedback data back to the first audio device via another mesh PDU. The first audio device may then incorporate the feedback data into the broadcast audio stream for distribution to the other audio devices in the system. The feedback data may include data regarding device status, volume level, etc. In some examples, the feedback data may also include provisioning or reprovisioning information, such as device identification information.

In some examples, the aforementioned process may be used to change the source of the broadcast audio stream. For example, the second audio device may receive input data indicating that the user would like to switch the source of the broadcast audio stream from the first audio device to the second audio device. This request is conveyed to the first audio device via the mesh PDU. The first audio device then circulates command data corresponding to this request among the other devices in the system via the broadcast audio stream. The command data prepares the other devices to receive the new broadcast audio stream from the second audio device.

Generally, in one aspect, a method for controlling one or more audio devices is provided. The method includes transmitting, from a first audio device, a broadcast stream.

The method further includes receiving input data from a second audio device. The input data is related to adjusting playback of the broadcast stream.

The method further includes transmitting command data from the first audio device to one or more other audio devices. The command data is based on the input data. The command data is time synchronized with the broadcast stream to prevent overlap with the broadcast stream.

According to an example, a broadcast protocol data unit of the broadcast stream includes the command data.

According to an example, the broadcast protocol data unit includes sequence data, source data, and/or destination data.

According to an example, the one or more other audio devices implement the command data based on the sequence data, the source data, and/or the destination data.

According to an example, the broadcast protocol data unit further includes an audio payload.

According to an example, the audio payload corresponds to an audio stream transmitted by an external audio device.

According to an example, the command data is a relay of the input data.

According to an example, the input data is transmitted from the second audio device to the first audio device via a mesh protocol data unit.

According to an example, the mesh protocol data unit is time synchronized with the broadcast stream to prevent overlap with the broadcast stream.

According to an example, the input data is a request to change transmission of the broadcast stream from the first audio device to the second audio device. The command data is configured to enable the second audio device to transmit the broadcast stream. The command data is further configured to enable the one or more other audio devices to receive the broadcast stream from the second audio device.

According to an example, the command data includes timing information. The one or more other audio devices execute the adjustment of the playback of the broadcast stream according to the timing information.

According to an example, the timing information is related to the broadcast stream.

According to an example, the input data corresponds to a volume control command or a status check command.

According to an example, the one or more other audio devices transmit feedback data corresponding to the adjustment of the playback of the broadcast stream.

According to an example, the feedback data is transmitted via a mesh protocol data unit.

According to an example, the second audio device is configured to receive the broadcast stream from the first audio device.

Generally, in another aspect, a system for controlling one or more audio devices is provided. The system includes a first audio device. The first audio device is configured to transmit a broadcast stream.

The first audio device is further configured to receive input data from a second audio device. The second audio device is configured to receive the broadcast stream from the first audio device. The input data is related to adjusting playback of the broadcast stream.

The first audio device is further configured to transmit command data to one or more other audio devices. The command data is based on the input data. The command data is time synchronized with the broadcast stream to prevent overlap with the broadcast stream.

According to an example, the first audio device, the second audio device, and each of the one or more other audio devices are speakers.

According to an example, the second audio device includes a user interface configured to receive the input data.

According to an example, the second audio device receives the input data via an external audio device.

According to an example, the one or more other audio devices are positioned outside of a transmission range of the second audio device.

In various implementations, a processor or controller can be associated with one or more storage media (generically referred to herein as “memory,” e.g., volatile and non-volatile computer memory such as ROM, RAM, PROM, EPROM, and EEPROM, floppy disks, compact disks, optical disks, magnetic tape, Flash, OTP-ROM, SSD, HDD, etc.). In some implementations, the storage media can be encoded with one or more programs that, when executed on one or more processors and/or controllers, perform at least some of the functions discussed herein. Various storage media can be fixed within a processor or controller or can be transportable, such that the one or more programs stored thereon can be loaded into a processor or controller so as to implement various aspects as discussed herein. The terms “program” or “computer program” are used herein in a generic sense to refer to any type of computer code (e.g., software or microcode) that can be employed to program one or more processors or controllers.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also can appear in any disclosure incorporated by reference should be accorded a meaning most consistent with the particular concepts disclosed herein.

Other features and advantages will be apparent from the description and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the various embodiments.

FIG. 1 is a schematic view of a system for wireless communication, in accordance with an example.

FIG. 2 is a diagram illustrating time synchronization between broadcast intervals and mesh intervals, in accordance with an example.

FIG. 3 illustrates an example of a mesh protocol data unit transmitted by an audio device, in accordance with an example.

FIG. 4 illustrates a broadcast protocol data unit transmitted by an audio device, in accordance with an example.

FIG. 5 illustrates a second mesh protocol data unit transmitted by an audio device, in accordance with an example.

FIG. 6 is a schematic view of another system for wireless communication, in accordance with an example.

FIG. 7 is a schematic view of a variation of the system for wireless communication of FIG. 6 where the second audio device is the audio broadcaster, in accordance with an example.

FIG. 8 is a schematic diagram of a first audio device, in accordance with an example.

FIG. 9 is a schematic diagram of a second audio device, in accordance with an example.

FIG. 10 is a schematic diagram of a third audio device, in accordance with an example.

FIG. 11 is a flow chart of a method for controlling one or more audio devices, in accordance with an example.

### DETAILED DESCRIPTION

The present disclosure is generally directed to systems and methods for controlling audio devices. In particular, the systems and methods use a combination of mesh advertisements and broadcast audio streams to control the audio devices. Critically, the broadcast audio stream and the transmissions of the mesh advertisements are time synchronized to prevent temporal overlap, thereby enabling all audio devices within range to receive both the broadcast audio stream and the mesh advertisements. The broadcast audio streams are implemented according to the Bluetooth Low Energy (LE) Audio protocol. An example system may include a first audio device, a second audio device, and one or more additional audio devices. Each of these audio devices may be any type of Bluetooth enabled audio device, such as speakers. The first audio device may transmit a broadcast audio stream, such that the audio of the broadcast audio stream is rendered by the second audio device and each of the additional audio devices. Optionally, the first audio device may also render audio of the broadcast stream. The second audio device receives (such as via a user interface) input data corresponding to a playback adjustment of the broadcast audio stream, such as a volume level change. The second audio device then transmits a mesh protocol data unit (PDU) containing data corresponding to the desired playback adjustment. The first audio device receives the mesh PDU and extracts data corresponding to the desired playback adjustment. The first audio device then generates command data based on the desired playback adjustment, and embeds the command data into the broadcast audio stream. In some example, generating the command data may including duplicating, copying, or relaying data received from the second audio device. Accordingly, when the broadcast audio stream is received by the additional audio devices, the additional audio devices also receive the command data to implement the desired playback adjustment, and all of the audio devices in the system may then execute the same playback adjustment.

The terms “broadcast stream” or “broadcast isochronous stream” as used herein, in addition to including their ordinary meaning or their meaning known to those skilled in the art, is intended to include to an isochronous data stream which does not require a preestablished communications link to be established between the source device sending data and the audio device receiving data and does not require acknowledgements or negative acknowledgements to be sent or received.

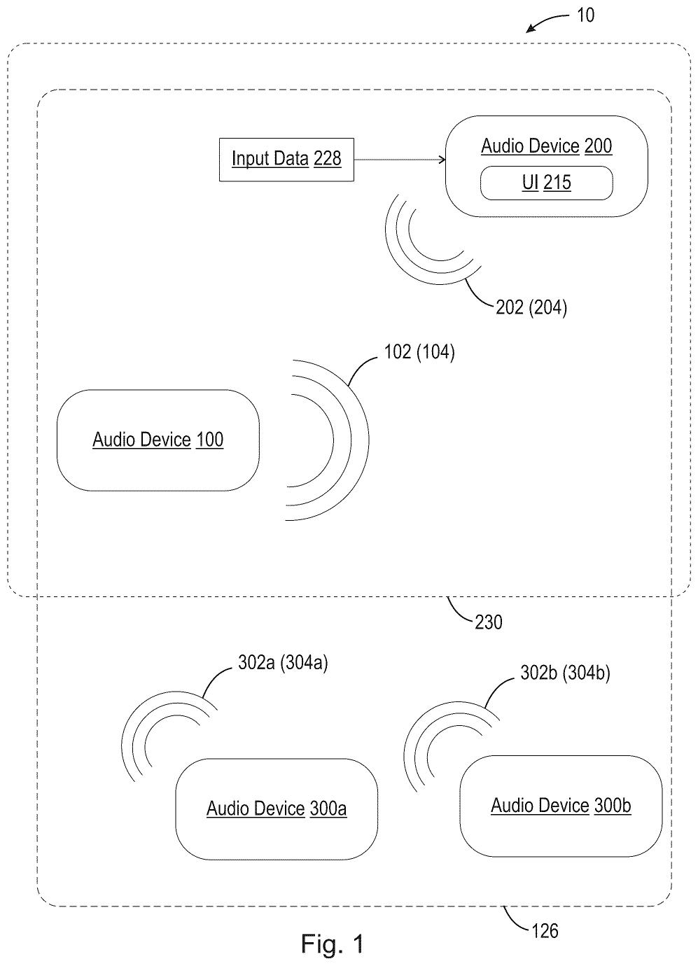

The following description should be read in view of FIGS. 1-11. FIG. 1 is a schematic view of the components of system 10 according to the present disclosure. In some examples, the system 10 includes a first audio device 100, a second audio device 200, and two additional audio devices 300a, 300b. In the non-limiting example of FIG. 1, the first device 100, the second device 200, and the third devices 300a, 300b are each audio loudspeakers, such as smart speakers, configured to render audio based on audio data received via wireless transmissions. In other examples, at least one of the aforementioned devices may be a device other than a speaker, such as a smartphone, tablet computer, audio headset, an earbud, earphones, etc.

In the example of FIG. 1, the system 10 is configured to enable all audio devices 100, 200, 300a, 300b to both simultaneously render the same audio as well as adjust the playback of the audio by one or more of the audio devices 100, 200, 300a, 300b. For example, each of the audio devices 100, 200, 300a, 300b may be brought to a social gathering by a different attendee. In order to achieve maximum audio playback, the system 10 enables the attendees to simultaneously playback the same audio on each of the audio devices 100, 200, 300a, 300b. Further, if the volume needs to be adjusted, the system 10 enables volume control of all of the audio devices 100, 200, 300a, 300b simultaneously, without requiring the attendees to manually adjust the volume on each audio device 100, 200, 300a, 300b. In another example, each of the audio devices 100, 200, 300a, 300b may be components of a multi-speaker surround sound system, such as a 5.1 surround sound system. The system 10 not only enables each audio device 100, 200, 300a, 300b to simultaneously playback the same audio, the system 10 also enables a user to simultaneously control and adjust each of the audio devices 100, 200, 300a, 300b.

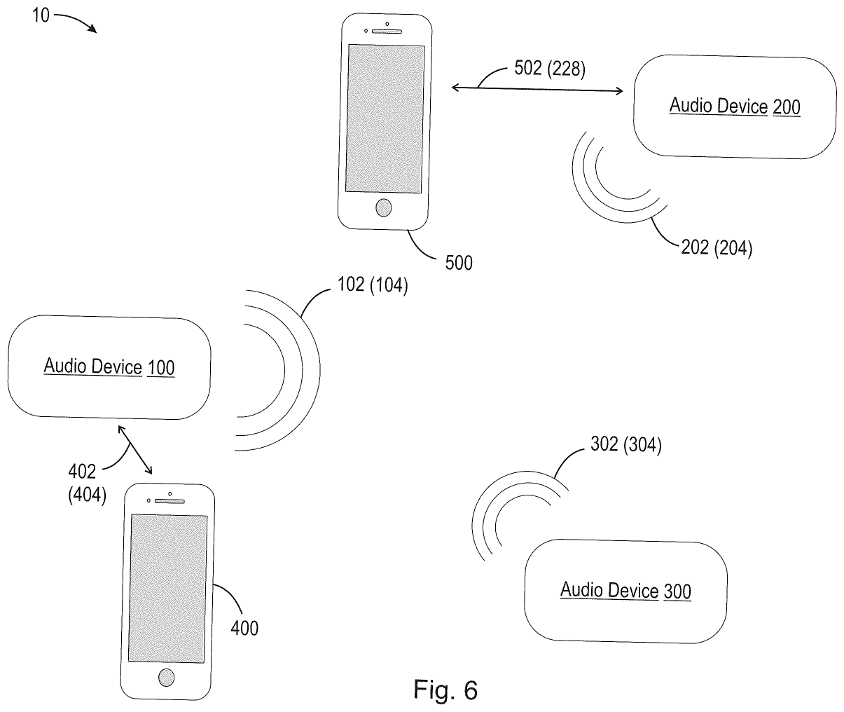

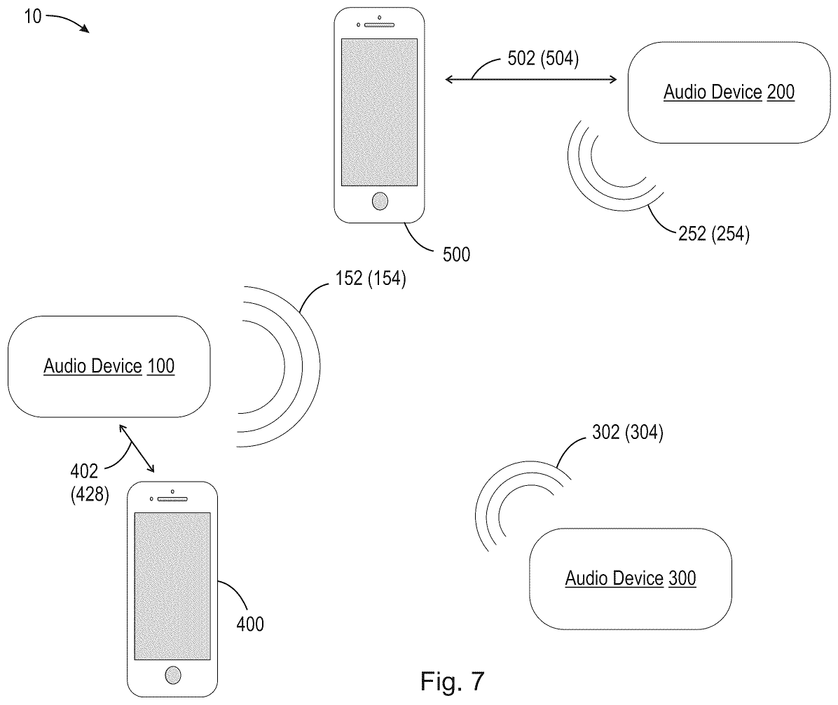

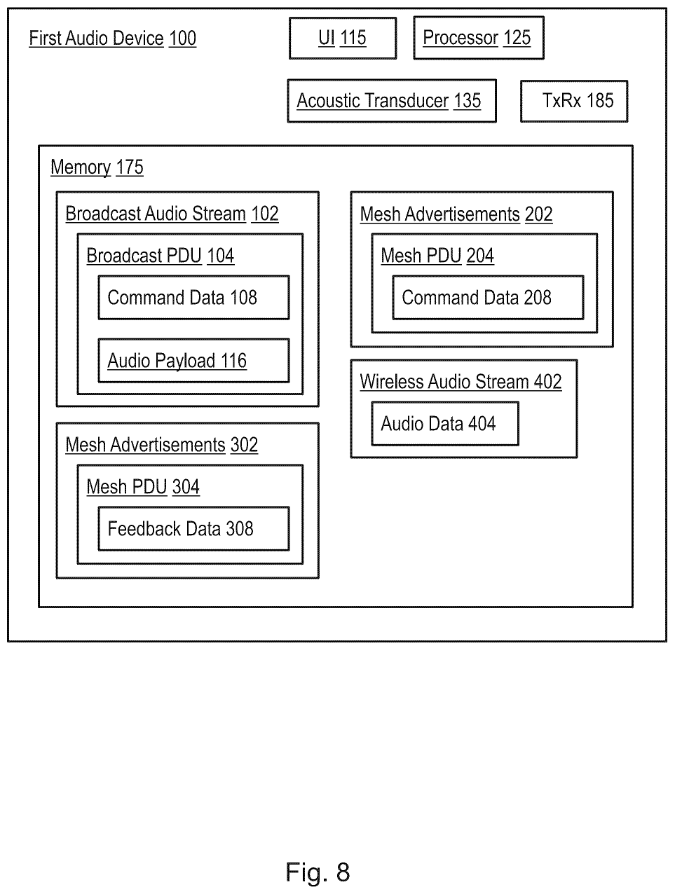

Generally, the simultaneous audio playback of the system 10 is enabled by a broadcast stream, such as broadcast audio stream 102 transmitted by the first audio device 100. As will be described in more detail with references to FIG. 4, the broadcast audio stream 102 transmits a series of broadcast PDUs 104 containing, among other information, audio data to each audio device 200, 300a, 300b within a transmission range 126 of the first audio device 100. The audio data could correspond to music, spoken word, or any other type of content. The transmission range 126 shown in FIG. 1 is for demonstrative purposes only. In some examples, the audio data may be generated by the first audio device 100. In other examples, such as the example of FIG. 6, the audio data may be provided by an external device 400, such as a smartphone wirelessly connected to the first audio device 100. As illustrated in FIG. 8, the first device 100 also includes an acoustic transducer 135 configured to render audio based on the audio data. Accordingly, the playback audio of the first audio device 100 will match the playback audio of the other audio devices 200, 300a, 300b.

As each audio device 100, 200, 300a, 300b is now playing back the same audio, the system 10 also enables a user to adjust the playback on two or more of the audio devices 100, 200, 300a, 300b simultaneously. For example, a user may wish to increase the playback volume on all of the audio devices 100, 200, 300a, 300b simultaneously. Accordingly, the user may provide input data 228 into the first audio device 100. In one example, the input data 228 may be received via a user interface 215 of the audio device 200. The user interface 215 may take a variety of forms, such as physical buttons (including volume up and volume down buttons), a touch screen, a microphone (for capturing spoken commands), a motion sensor (triggering audio adjustment based on motion of the audio device 100), etc. In some examples, as shown in FIG. 6, the input data 228 may be received via an external device 400, such as a smartphone. In some examples, the external device 400 may be wirelessly connected to the audio device 200.

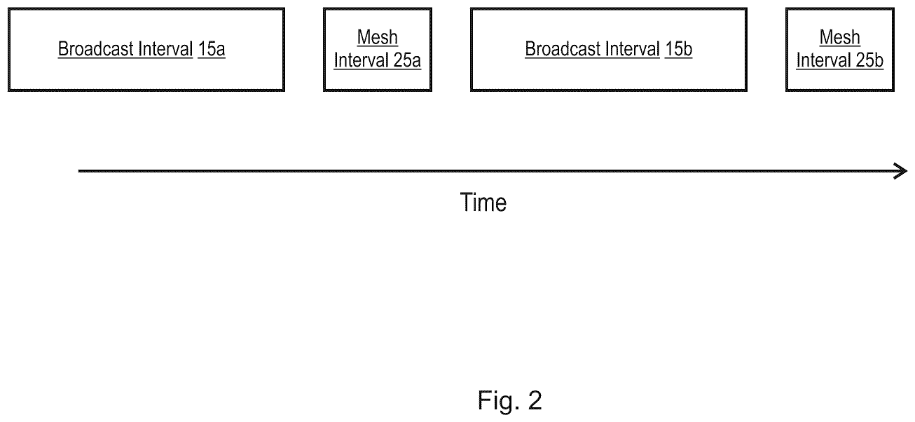

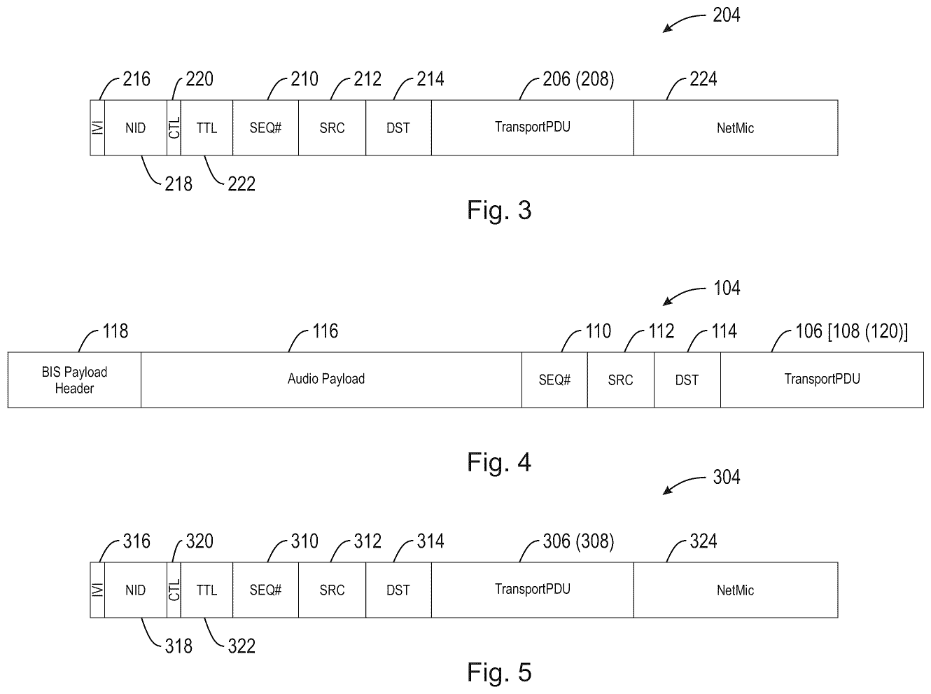

The input data 228 is then incorporated in a mesh PDU 204 conveyed by mesh advertisements 202. An example mesh PDU 204 is shown in more detail in FIG. 3. Notably, the mesh advertisements 202 are transmitted during mesh intervals 25, while broadcast audio stream 100 is transmitted during broadcast intervals 15. These intervals 15, 25 are illustrated in FIG. 2. As shown in FIG. 2, the broadcast intervals 15 and the mesh intervals 25 are synchronized to prevent temporal overlap between the broadcast audio stream 102 and the mesh advertisements 202. Accordingly, devices within the transmission range 126 of the first audio device 100 and the transmission range 230 of the second audio device 200 will be able to receive both the broadcast PDUs 104 and the mesh PDUs 204 due to the time synchronization. The time synchronization of the broadcast intervals 15 and the mesh intervals 25 may be pre-programmed into each of the audio devices 100, 200, 300a, 300b of FIG. 1.

The non-limiting example of the mesh PDU 204 of FIG. 3 includes a variety of data. The mesh PDU 204 includes a transport PDU 206 configured to convey command data 208. The command data 208 represents the desired playback adjustment. In some examples, the command data 208 may simply be the input data 228 received by the second audio device 200. In other examples, the input data 228 may require processing by the second audio device 200 to generate command data 208 capable of being received, processed, and implemented by the other audio devices 100, 300a, 300b. In other examples, the input data 228 could originate from another device, such as the first audio device 100. The mesh PDU 204 of FIG. 3 further include sequence data 210, source data 212, destination data 214, an initialization vector index 216, a NetKey identifier 218, network control data 220, time to live data 222, and network message integrity check data 224. The sequence data 210 may be used to indicate the sequence of several mesh PDUs 204, as the same mesh PDU 204 will typically be transmitted several times. Thus, the sequence data 210 may be used by a receiving device to prevent the receiving device from executing the command data 208 more than once. The source data 212 may be used to indicate the publisher of the mesh PDU 204. In the example of FIG. 1, the source data 212 will correspond to the second audio device 200. The destination data 214 may be used to indicate the subscribers of the mesh PDU 204. The subscribers are the devices configured to execute the command data 208 conveyed by the mesh PDU 204. For example, if the user wishes to lower the volume on all of the audio devices of FIG. 1, the destination data 214 will identify the first device 100 and the third devices 300a, 300b as subscribers.

The mesh PDU 204 may be received by any audio device within a transmission range 230 of the second audio device 200. As shown in FIG. 1, only the first audio device 100 is within the transmission range 230 of the second audio device 200. As the additional audio devices 300a, 300b are outside of the transmission range 230, the command data 208 of the mesh PDU 204 will need to be relayed to the additional audio devices 300a, 300b in order to simultaneously control all of the audio devices 100, 200, 300a, 300b of the system 10. In further examples, other devices within the transmission range 230 of the second audio device 200 may not be configured to receive or “listen to” mesh advertisements 202 during the mesh intervals 25; the command data 208 will need to be relayed to those devices as well.

The first audio device 100 effectively relays the command data 208 of the mesh PDU 204 using a broadcast PDU 104 of the broadcast stream 102. The first audio device 100 is positioned such that the other audio devices 200, 300a, 300b may receive the broadcast stream 102 from the first audio device 100. Accordingly, the first audio device 100 transmits a series of broadcast PDUs 104 via the broadcast audio stream 102. A non-limiting example of a broadcast PDU 104 is shown in FIG. 4. The broadcast PDU 104 includes a transport PDU 106, sequence data 110, source data 112, destination data 114, audio payload data 116, and, optionally, a broadcast isochronous stream payload header 118. The transport PDU 106 includes command data 108. The command data 108 corresponds to the command data 208 of the mesh PDU 204. In some examples, the command data 108 of the broadcast PDU may be a simple relay of the command data 208 of the mesh PDU 204. In other examples, the first audio device 100 may process or translate the command data 208 of the mesh PDU 204 to generate the command data 108 of the broadcast PDU 104. For example, if the command data 208 of the mesh PDU 204 indicates a “decrease volume” command, the first audio device 100 may translate the “decrease volume” command into a “set volume level” command. In particular, it may be necessary to translate the command data 208 into a universally understood command or setting if the system 10 includes different types, makes, or models of audio devices 100, 200, 300a, 300b. In some examples, the command data 108 may include timing information 120 used to synchronize the implementation of the command data 108 by the various receiving devices. For instance, the timing information 120 may be used to synchronize volume reduction among the first audio device 100 and the additional audio devices 300a, 300b. In some examples, the timing information 120 may be implicit in the command data 108 or earlier received command data 108. For example, earlier-received command data 108 may instruct an audio device to apply a change volume command some amount of time (such as five milliseconds) after the first occurrence of the change volume command in the command data 108. This timing may be measured in terms of units of broadcast intervals 15 using a counter which decrements at each interval 15. For example, the counter may count down from 5 to 0, decreasing by one at each broadcast interval 15. In further examples, the command data 108 may also include provisioning or reprovisioning information, such as device configuration information.

The broadcast PDU 104 also includes sequence data 110, source data 112, and destination data 114 corresponding to the sequence data 210, source data 212, and destination data 214, respectively, of the mesh PDU 204. The audio payload data 116 is to be rendered by the audio devices 100, 300a, 300b receiving the broadcast audio stream 102. Accordingly, the broadcast PDU 104 typically conveys two types of data; (1) audio data for playback and (2) control data to adjust the playback by the receiving device. Further, the first audio device 100 may implement the command data 108 to control its own playback of the audio data, such as to reduce volume. However, in some examples, the broadcast audio stream 102 may not include audio data for playback. The lack of audio data could correspond to periods of no input or to situations where the audio for playback is sourced from another device. In these examples, the broadcast PDU 104 may still be used to control the receiving device in a synchronous manner, even if the broadcast PDU is not providing audio data.

The additional audio devices 300a, 300b receive the broadcast PDU 104 via the broadcast audio stream 102. Accordingly, the additional audio devices 300a, 300b both (1) playback audio corresponding to the audio payload data 116 and (2) adjust the audio playback based on the command data 208. Once the audio payload 116 has been rendered and the command data 208 has been implemented, the additional audio devices 300a, 300b may then transmit mesh PDUs 304a, 304b in a mesh advertisement 302a, 302b. An example of the mesh PDU 304 is shown in FIG. 5. Like the mesh PDU 204 transmitted by the second audio device 200, the mesh PDU transmitted by the additional audio devices 300a, 300b may include a transport PDU 306, sequence data 310, source data 312, destination data 314, an initialization vector index 316, a NetKey identifier 318, control data 320, time to live data 322, and network message integrity check data 324. The transport PDU 306 may contain feedback data 308 indicative of the implementation of the command data 208 and/or general status information regarding the additional audio devices 300a, 300b. For example, the feedback data 308 could include current volume settings, battery life, and other information. In some examples, the feedback data 308 may also include provisioning or reprovisioning information, such as device identification information. The mesh PDU 304 may be transmitted according to the mesh intervals 25 as shown in FIG. 2.

The first audio device 100 may receive mesh PDUs 304a, 304b transmitted by the third devices 300a, 300b. The first audio device 100 may then analyze the feedback data 308 to store the current status of the additional audio devices 300a, 300b. The first audio device 100 may also embed the feedback data 308 or other data regarding the status of the additional audio devices 300a, 300b into the transport PDU 106 of the broadcast PDU 104 to convey the statuses of the additional audio devices to the second audio device 200. In some examples, the audio devices 100, 200, 300a, 300b may store look-up tables tracking the statuses of the other audio devices 100, 200, 300a, 300b in the system 10.

While the aforementioned example describes a volume adjustment applied to each of the audio devices 100, 200, 300a, 300b in the system 10, the volume adjustment (or any other command) may only be applied to a subset of one or more of the audio devices 100, 200, 300a, 300b. For example, the input data 228 received by the second audio device 200 may include a selection of the audio device 100, 300a, 300b to control, such as a first additional audio device 300a. Thus, the destination data 214 of the mesh PDU 214 may indicate that only the first additional audio device 300a will implement a volume adjustment, while the volume of a second additional audio device 300b will remain constant. Further, the input data 228 may correspond to commands other than volume adjustment. For example, the input data 228 could trigger a status check of one or more of the audio devices 100, 300a, 300b. The status check could provide a variety of information, such as battery life, Bluetooth connection status, current audio settings, etc.

Further, the system 10 described above may implement a wide array of playback adjustments in addition to volume control to one or more of the audio devices 100, 200, 300a, 300b. For example, the playback adjustments may include pausing and unpausing playback, switching playback to a subsequent or previous track in a playlist or album, advancing or rewinding playback within a track, changing the content of a stream (such as playing a different playlist, a different song, or a different artist), changing the content source for the stream (such as switching between different music streaming services), changing the input source of the stream (such as from an Internet radio source to an HDMI input connected to a television set causing television audio to be broadcasted to the other devices), or changing audio equalizer settings.

In some examples, the playback adjustments may include changing what portion of the received stream is played back, such as changing from playing full audio content to a portion of the audio content (such as left, right, rear, or front audio channels). For example, open ear wearable devices could be configured to playback only the rear channels of the stream to supplement one or more front channels being played back by another device, such as a sound bar, enabling a personalized surround sound experience. In other examples, two speakers may change from playing full audio to one speaker playing a left channel, and the other playing a right channel. While the aforementioned examples describe selecting or deselecting channels of an audio stream for playback, other aspects of the audio stream may be similarly selected or deselected.

Some of the aforementioned playback adjustments may not require command data 108 to be circulated among the other devices 300a, 300b, as the playback adjustment may be entirely implemented via the first audio device 100. For example, the first audio device 100 may simply change the broadcast audio stream 102 without requiring the other devices 300a, 300b to implement additional commands. Accordingly, the input data 228 may be conveyed to the second audio device 200 in such a manner as to prevent time and/or frequency overlap or interference with the broadcast audio stream 102. Further, in some examples, the command data 208 may be transmitted over different frequencies as the broadcast audio stream 102 and/or the input data 228.

FIG. 6 illustrates a variation of FIG. 1 where the first audio device 100 is wirelessly connected to a first external device 400, and the second audio device 200 is wirelessly connected to a second external device 500. The first audio device 400 is configured to provide a wireless audio stream 402 of audio data 404 to the first audio device 100. In this example, a user may select audio (such as via media player program or an audio streaming service) to be played by the audio devices 100, 200, 300 of the system 10. The audio data 404 may be played back by the acoustic transducer 135 of the first audio device 100. The audio data 404 may also be embedded in the audio payload 116 of the broadcast PDUs 104 of the broadcast audio stream 102, thereby conveying the audio data 404 to the second and third audio devices 200, 300. The wireless audio stream 402 may be formed via any practical wireless protocol. In some examples, the wireless audio stream 402 may be formed via a Bluetooth protocol, such as Bluetooth Classic, Bluetooth Low Energy (BLE), or LE Audio. In further examples, the wireless audio stream 402 may be embodied as a Connected Isochronous Stream or a Broadcast Isochronous Stream.

The second external device 500 is configured to provide input data 228 to the audio device via an input stream 502. In this example, the user may enter input data 228 into the second external device 500, rather than directly into the second audio device 200. The input data 228 may correspond to a volume control of one or more of the audio devices 100, 200, 300 of the system 10. The input data 228 could also correspond to a status check of one or more of the audio devices 100, 200, 300. In some examples, the input stream 502 may be wireless. The wireless input stream 502 may be formed via any practical wireless protocol. In some examples, the wireless input stream 502 may be formed via a Bluetooth protocol, such as Bluetooth Classic, Bluetooth Low Energy (BLE), or LE Audio. In further examples, the wireless input stream 502 may be embodied as a Connected Isochronous Stream or a Broadcast Isochronous Stream. In other examples, the input stream 502 may be facilitated by a wired connection, such as the television set connected to a soundbar. In these examples, the input stream 502 may be transmitted via an Ethernet or a HDMI cable.

In some examples, the input data 228 may correspond to a request to designate another audio device of the system 100 as the audio broadcaster. In the example of FIG. 6, the first audio device 100 may be considered the audio broadcaster, as the first audio device 100 transmits the broadcast audio stream 102. The broadcast audio stream 102 comprises a series of broadcast PDUs 104 conveying both the command data 108 and the audio payload 116.

In this example, the user may enter input data 228 into the second external device 500 indicative of designating the second audio device 200, rather than the first audio device 100, as the broadcaster. The second audio device 200 generates a mesh PDU 204 with command data 208 corresponding to the broadcaster switch. The mesh advertisements 202 convey the mesh PDU 204 to the first audio device 100. The first audio device 100 generates command data 108 based on the command data 208 of the mesh PDU 204. The command data 108 informs the receiving audio devices that the first audio device 100 will be the new audio broadcaster. Accordingly, the command data 108 may configure the receiving audio devices to receive a new broadcast audio stream from the second audio device 200. The command data 108 may also include timing information 120 to synchronize the broadcaster switch among the audio devices 100, 200, 300 of the system 10. The timing information 120 may include information about the new broadcaster, such that the other audio devices may synchronize to the new broadcast audio stream without following the standard onboarding scheme of capturing a periodic advertisement which points to the broadcast audio stream. The command data 108 is embedded into the broadcast PDUs 104 of the broadcast audio stream 102 for transmission.

The results of the transmission of the broadcast PDUs 104 and subsequent broadcaster switch is shown in FIG. 7. As shown in FIG. 7, the second audio device 200 now begins to transmit a second broadcast audio stream 252 comprising a series of second broadcast PDUs 254. The second broadcast PDUs 254 may include audio data 504 provided by the second external device 500. The audio of the second broadcast PDUs 254 may be played back by the first and third audio devices 100, 300 if they are in transmission range of the second audio device 200.

Further, a user wishing to control audio playback may enter input data 428 into the first external device 400. The first audio device 100 may then generate command data 108 corresponding to the input data 428. The command data 108 may be embedded into mesh PDUs 154 conveyed by mesh advertisements 152. The mesh PDUs 154 may be received by the second audio device 200, which may incorporate command data 208 (corresponding to command data 108) into the second broadcast PDUs 254, thereby circulating the command data 208 among the audio devices of the system 10.

FIG. 8 schematically illustrates the first audio device 100 previously depicted in FIGS. 1 and 6. Broadly, the first audio device 100 may include a user interface 115, a processor 125, an acoustic transducer 135, and a transceiver 185. The first device 100 may be embodied as a speaker. However, in other examples, the first audio device 100 may be any other device capable of transmitting the broadcast audio stream 102, receiving the mesh advertisements 202, 302 and the wireless audio stream 402, and playing back audio via the acoustic transducer 135. As shown in FIGS. 1 and 6, the first audio device 100 is configured to transmit the broadcast audio stream 102. The broadcast audio stream 104 includes a series of broadcast PDUs 104. The broadcast PDUs 104 include command data 108 and an audio payload 116, among other data. The first audio device 100 is further configured to receive mesh advertisements 202 from the second audio device 200. The mesh advertisements 202 include mesh PDUs 204. The mesh PDUs 204 include command data 208. The first audio device 100 is further configured to receive mesh advertisements 302 from the third audio device 300. The mesh advertisements 302 include mesh PDUs 304. The mesh PDUs include feedback data 308. The first audio device 100 is further configured to receive a wireless audio stream 402 from the first external device 400. The wireless audio stream 402 includes audio data 404. In some examples, the audio data 404 may be generated by the first audio device 100 itself, rather than received by another device.

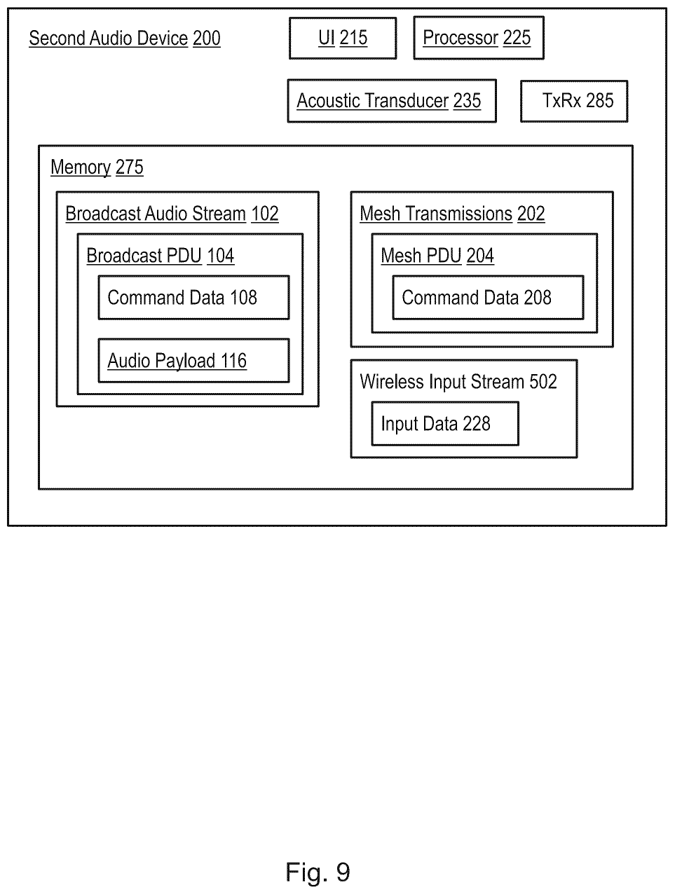

FIG. 9 schematically illustrates the second audio device 200 previously depicted in FIGS. 1 and 6. Broadly, the second audio device 200 may include a user interface 215, a processor 225, an acoustic transducer 235, and a transceiver 285. The second audio device 200 may be embodied as a speaker. However, in other examples, the second audio device 200 may be any other device capable of transmitting mesh advertisements 202, receiving the broadcast audio stream 102 and the wireless input stream 502, and playing back audio via the acoustic transducer 235. As shown in FIGS. 1 and 6, the first audio device 100 is configured to transmit the mesh advertisements 202. The mesh advertisements 202 include mesh PDUs 204. The mesh PDUs include command data 208. The second audio device 200 is further configured to receive the broadcast audio stream 102. The broadcast audio stream 102 includes a series of broadcast PDUs 104. The broadcast PDUs 104 include command data 108 and an audio payload 116, among other data. The second audio device 200 is further configured to receive a wireless input stream 502 from the second external device 500. The wireless input stream 502 includes input data 228. In some examples, the input data 228 may be received by the second audio device 200 itself, such as via the user interface 215.

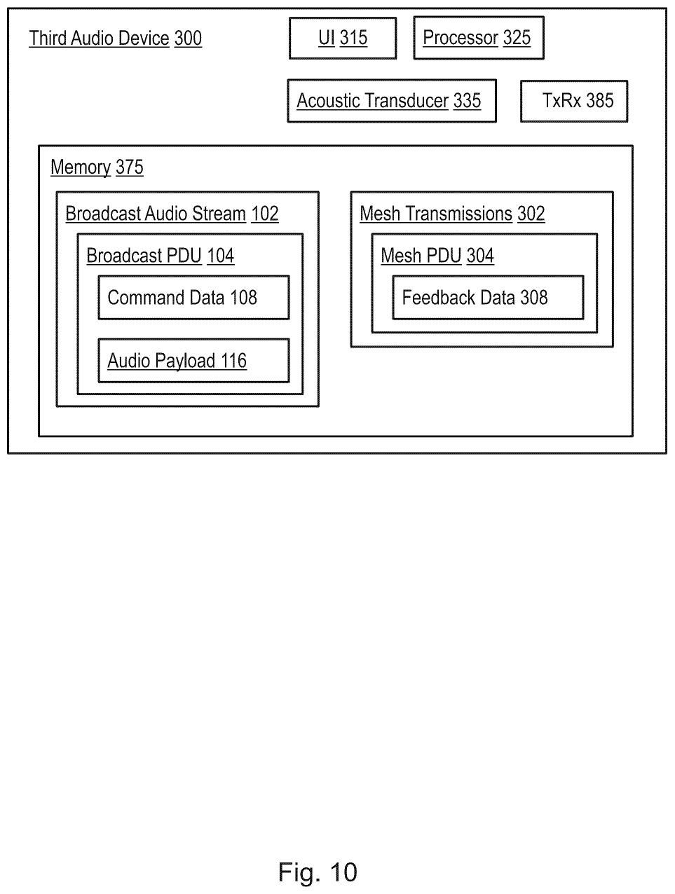

FIG. 10 schematically illustrates the third audio device 300 previously depicted in FIGS. 1 and 6. Broadly, the third audio device 300 may include a user interface 315, a processor 325, an acoustic transducer 335, and a transceiver 385. The third audio device 300 may be embodied as a speaker. However, in other examples, the third audio device 300 may be any other device capable of transmitting mesh advertisements 302, receiving the broadcast audio stream 102, and playing back audio via the acoustic transducer 335. As shown in FIGS. 1 and 6, the third audio device 300 is configured to transmit the mesh advertisements 302. The mesh advertisements 302 include mesh PDUs 304. The mesh PDUs 304 include feedback data 308. The third audio device 300 is further configured to receive the broadcast audio stream 102. The broadcast audio stream 102 includes a series of broadcast PDUs 104. The broadcast PDUs 104 include command data 108 and an audio payload 116, among other data.

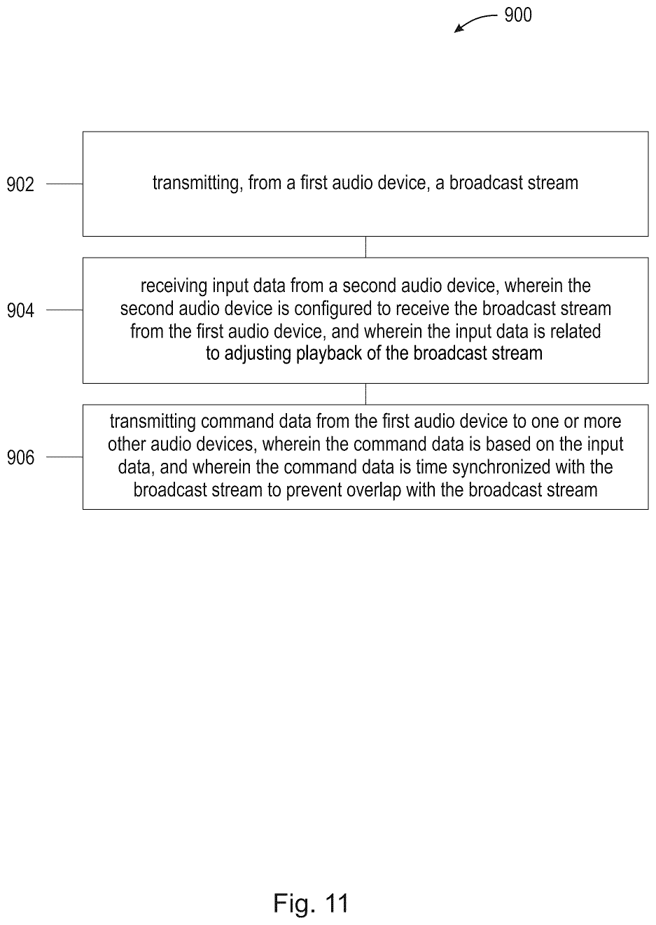

FIG. 11 is a flowchart of a method 900 for controlling one or more audio devices, according to various embodiments of the invention. Referring to FIGS. 1-11, the method 900 includes, in step 902, transmitting, from a first audio device 100, a broadcast stream 102.

The method 900 further includes, in step 904, receiving input data 228 from a second audio device 200. The second audio device 200 is configured to receive the broadcast stream 102 from the first audio device 100. The input data 228 is related to adjusting playback of the broadcast stream 102.

The method 900 further includes, in step 906, transmitting command data 108 from the first audio device 100 to one or more other audio devices 300. The command data 108 is based on the input data 228. The command data 108 is time synchronized with the broadcast stream 102 to prevent overlap with the broadcast stream 102.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The above-described examples of the described subject matter can be implemented in any of numerous ways. For example, some aspects can be implemented using hardware, software or a combination thereof. When any aspect is implemented at least in part in software, the software code can be executed on any suitable processor or collection of processors, whether provided in a single device or computer or distributed among multiple devices/computers.

The present disclosure can be implemented as a system, a method, and/or a computer program product at any possible technical detail level of integration. The computer program product can include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some examples, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to examples of the disclosure. It will be understood that each block of the flowchart illustrations and/or block diagrams, and combinations of blocks in the flowchart illustrations and/or block diagrams, can be implemented by computer readable program instructions.

The computer readable program instructions can be provided to a processor of a, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram or blocks.

The computer readable program instructions can also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various examples of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Other implementations are within the scope of the following claims and other claims to which the applicant can be entitled.

While various examples have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the examples described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific examples described herein. It is, therefore, to be understood that the foregoing examples are presented by way of example only and that, within the scope of the appended claims and equivalents thereto, examples can be practiced otherwise than as specifically described and claimed. Examples of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

What is claimed is:

1. A method for controlling one or more audio devices, comprising:
transmitting, from a first audio device, a broadcast stream;
receiving input data from a second audio device, wherein the input data is related to adjusting playback of the broadcast stream; and
transmitting command data from the first audio device to one or more other audio devices, wherein the command data is based on the input data, and wherein the command data is time synchronized with the broadcast stream to prevent overlap with the broadcast stream.

2. The method of claim 1, wherein a broadcast protocol data unit of the broadcast stream includes the command data.

3. The method of claim 2, wherein the broadcast protocol data unit comprises sequence data, source data, and/or destination data.

4. The method of claim 3, wherein the one or more other audio devices implement the command data based on the sequence data, the source data, and/or the destination data.

5. The method of claim 2, wherein the broadcast protocol data unit further includes an audio payload.

6. The method of claim 5, wherein the audio payload corresponds to an audio stream transmitted by an external audio device.

7. The method of claim 1, wherein the command data is a relay of the input data.

8. The method of claim 1, wherein the input data is transmitted from the second audio device to the first audio device via a mesh protocol data unit.

9. The method of claim 8, wherein the mesh protocol data unit is time synchronized with the broadcast stream to prevent overlap with the broadcast stream.

10. The method of claim 1, wherein the input data is a request to change transmission of the broadcast stream from the first audio device to the second audio device, and wherein the command data is configured to enable the second audio device to transmit the broadcast stream and to enable the one or more other audio devices to receive the broadcast stream from the second audio device.

11. The method of claim 1, wherein the command data comprises timing information, and wherein the one or more other audio devices execute the adjusting of the playback of the broadcast stream according to the timing information.

12. The method of claim 11, wherein the timing information is related to the broadcast stream.

13. The method of claim 1, wherein the input data corresponds to a volume control command or a status check command.

14. The method of claim 1, wherein the one or more other audio devices transmit feedback data corresponding to the adjusting of the playback of the broadcast stream, and wherein the feedback data is transmitted via a mesh protocol data unit.

15. The method of claim 1, wherein the second audio device is configured to receive the broadcast stream from the first audio device.

16. A system for controlling one or more audio devices, comprising:
a first audio device configured to:
transmit a broadcast stream;
receive input data from a second audio device, wherein the input data is related to adjusting playback of the broadcast stream; and
transmit command data to one or more other audio devices, wherein the command data is based on the input data, and wherein the command data is time synchronized with the broadcast stream to prevent overlap with the broadcast stream.

17. The system of claim 16, wherein the first audio device, the second audio device, and each of the one or more other audio devices are speakers.

18. The system of claim 16, wherein the second audio device comprises a user interface configured to receive the input data.

19. The system of claim 16, wherein the second audio device receives the input data via an external audio device.

20. The system of claim 16, wherein the one or more other audio devices are positioned outside of a transmission range of the second audio device.
